(19) United States
(12) Patent Application Publication
(10) Pub. No.: US 2023/0311304 A1
(43) Pub. Date: Oct. 5, 2023

(54) ROBOT CONTROLLER, CONTROL SYSTEM, AND CONTROL METHOD

(71) Applicant: KABUSHIKI KAISHA YASKAWA DENKI, Kitakyushu-shi (JP)

(72) Inventors: Yuto ISHIDA, Kitakyushu-shi (JP); Yuya MATSUNAGA, Kitakyushu-shi (JP)

(73) Assignee: KABUSHIKI KAISHA YASKAWA DENKI, Kitakyushu-shi (JP)

(21) Appl. No.: 18/169,879

(22) Filed: Feb. 16, 2023

(30) Foreign Application Priority Data
Mar. 8, 2022 (JP) 2022-035126

(51) Int. Cl. B25J 9/16; B25J 13/00; B25J 13/06; G05B 19/042

(52) U.S. Cl. CPC B25J 9/1602; B25J 13/006; B25J 13/06; G05B 19/0423; G05B 2219/25202

(57) ABSTRACT

A robot controller includes a Web API (Application Programming Interface) configured to receive a request from a Web client which is configured to execute a Single Page Application, response generation circuitry configured to generate a response to the request as updated data for the Single Page Application, and processing circuitry configured to execute a process with respect to a robot. The process corresponds to the request received by the Web API.

### CROSS-REFERENCE TO RELATED APPLICATIONS

The present application claims priority under 35 U. S. C. §119 to Japanese Patent Application No. 2022-035126, filed Mar. 8, 2022. The contents of this application are incorporated herein by reference in their entirety.

### BACKGROUND OF THE INVENTION

### Field of the Invention

The present disclosure relates to a robot controller, a control system, and a control method.

### Discussion of The Background

Japanese Patent Application Laid-Open No. 2011-224696 discloses an instruction reproduction apparatus having a controller for controlling the motion of a robot and an instruction pendant for an operator to instruct the robot to operate.

### SUMMARY OF THE INVENTION

According to one aspect of the present invention, a robot controller includes a Web API (Application Programming Interface) configured to receive a request from a Web client which is configured to execute a Single Page Application, processing circuitry configured to execute a process with respect to a robot, and response generation circuitry configured to generate a response to the request as updated data for the Single Page Application. The process corresponds to the request received by the Web API.

According to another aspect of the present invention, a control system includes a terminal configured to execute a Web client and a robot controller. The robot controller includes a Web API (Application Programming Interface) configured to receive a request from a Web client which is configured to execute a Single Page Application, processing circuitry configured to execute a process with respect to a robot, and response generation circuitry configured to generate a response to the request as updated data for the Single Page Application. The process corresponds to the request received by the Web API.

According to the other aspect of the present invention, a control method includes receiving by a Web API (Application Programming Interface) a request from a Web client which is configured to execute a Single Page Application, executing a process with respect to a robot, and generating a response to the request as updated data for the Single Page Application. The process corresponds to the request received by the Web API.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a schematic diagram illustrating a configuration of a robot system.

FIG. 2 is a block diagram illustrating a configuration of a robot controller.

FIG. 3 is a schematic diagram illustrating an execution screen of a Single Page Application.

FIG. 4 is a block diagram illustrating a hardware configuration of a robot controller and an operation terminal.

FIG. 5 is a flowchart illustrating the activation procedure of the Single Page Application.

FIG. 6 is a flowchart illustrating a request handling procedure.

FIG. 7 is a flowchart illustrating a processing procedure.

FIG. 8 is a flowchart illustrating an event monitoring procedure.

### DESCRIPTION OF THE EMBODIMENTS

Embodiments will be described in detail below with reference to the drawings. In the description, the same elements and elements having the same function are denoted by the same reference numerals, and duplicated description is omitted.

### Robot System

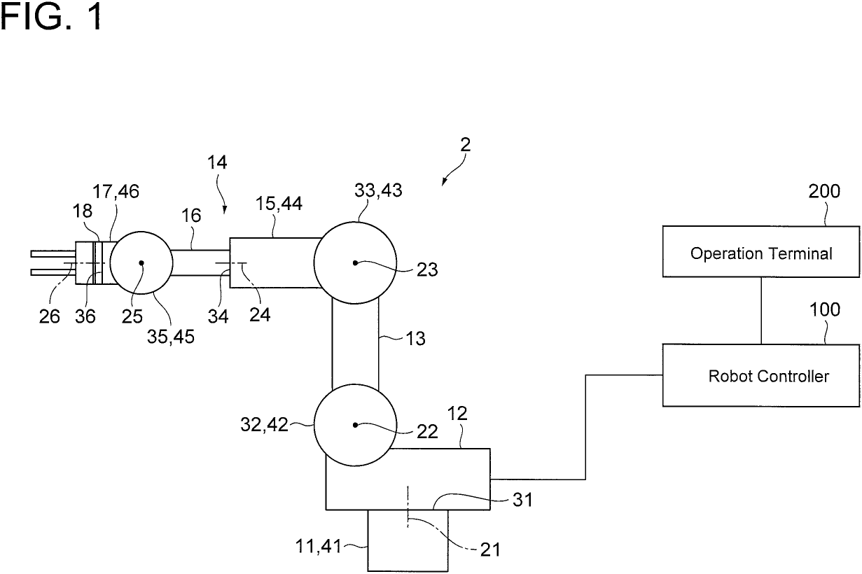

The robot system 1 shown in FIG. 1 is a so-called teaching/playback system in which the robot 2 is operated based on an operation program generated by teaching by an operator. As shown in FIG. 1, the robot system 1 includes a robot 2, a robot controller 100, and a terminal 200.

The robot 2 shown in FIG. 1 is a six-axis vertical articulated robot having a base portion 11, a turning portion 12, a first arm 13, a second arm 14, a third arm 17, a distal end portion 18, and an actuator 41, 42, 43, 44, 45, 46. The base portion 11 is installed on a floor surface, a wall surface, a ceiling surface, an unmanned carrier, or the like. The turning portion 12 is provided on the base portion 11 so as to turn around a vertical axis 21. The first arm 13 is connected to the turning portion 12 so as to swing around an axis 22 intersecting (e.g., orthogonal) the axis 21, and extends in a direction away from the axis 22. The crossing includes a case of being in a twisted relationship such as a so-called three-dimensional crossing. The same applies to the following.

The second arm 14 is connected to the distal end portion 18 of the first arm 13 so as to swing about an axis 23 substantially parallel to the axis 22, and extends in a direction away from the axis 23. The second arm 14 includes an arm base portion 15 and an arm end portion 16. The arm base portion 15 is connected to the distal end portion 18 of the first arm 13. The arm end portion 16 is connected to the distal end portion 18 of the arm base portion 15 so as to pivot about an axis 24 which intersects (e.g., is orthogonal to) the axis 23, and extends along the axis 24 in a direction away from the arm base portion 15.

The third arm 17 is connected to the distal end portion 18 of the arm end portion 16 so as to swing about an axis 25 which intersects (e.g., is orthogonal to) the axis 24. The distal end portion 18 is connected to the distal end portion 18 of the third arm 17 so as to pivot about an axis 26 which intersects (e.g., is orthogonal to) the axis 25.

Thus, the robot 2 has a joint 31 for connecting the base portion 11 and the turning portion 12, a joint 32 for connecting the turning portion 12 and the first arm 13, a joint 33 for connecting the first arm 13 and the second arm 14, a joint 34 for connecting the arm base portion 15 and the arm end portion 16 in the second arm 14, a joint 35 for connecting the arm end portion 16 and the third arm 17, and a joint 36 for connecting the third arm 17 and the distal end portion 18.

The actuator 41, 42, 43, 44, 45, 46 include, for example, an electric motor and a reduction gear, and drives each of the joints 31, 32, 33, 34, 35, 36. For example, the actuator 41 rotates the turning portion 12 around the axis 21, the actuator 42 rotates the first arm 13 around the axis 22, the actuator 43 rotates the second arm 14 around the axis 23, the actuator 44 rotates the arm end portion 16 around the axis 24, the actuator 45 rotates the third arm 17 around the axis 25, and the actuator 46 rotates the distal end portion 18 around the axis 26 .

The specific configuration of the robot 2 can be changed as appropriate. For example, the robot 2 may be a seven-axis redundant robot in which one axis joint is added to the six-axis vertical multi-joint robot described above, or may be a so-called scalar multi-joint robot.

The robot controller 100 operates the robot 2 based on an operation program registered in advance by teaching. The operation program includes a plurality of time-series operation commands. Each of the plurality of operation commands defines at least a target position of the distal end portion 18 and an operation speed of the distal end portion 18 up to the target position. The target position is information defining the coordinates of the distal end portion 18 in the robot coordinate system and the posture of the distal end portion 18 around each coordinate axis. The robot coordinate system is a three-dimensional coordinate system fixed to the base portion 11. The target position may be information that directly determines the coordinates and posture of the distal end portion 18, or may be information that indirectly determines the coordinates and posture of the distal end portion 18. A specific example of information that indirectly determines the coordinates and posture of the distal end portion 18 is a rotation angle of the joint 31, 32, 33, 34, 35, 36.

The teaching means an operation of registering an operation program including a plurality of operation commands corresponding to the plurality of target positions by teaching the plurality of target positions. The terminal 200 is used for an operation in teaching. For example, the terminal 200 is used for various operations such as an operation of moving the distal end portion 18 to an arbitrary position and an operation of adding an operation command for setting the position of the distal end portion 18 as the target position to an operation program.

In order to enable the various operations described above by the terminal 200, it is necessary to generate a user interface for various operations in the terminal 200. Hereinafter, a user interface for various operations is referred to as an “operation interface”. The terminal 200 forms an operation interface of the robot 2 by executing a Web application on the Web client.

The terminal 200 may be any type of terminal as long as it can configure an operation interface by executing a Web application and can communicate with the robot controller 100. For example, the terminal 200 may be a laptop computer, a tablet computer, or a smart phone.

The robot controller 100 executes processing for the robot 2 in response to a request from the user interface. For example, the robot controller 100 is configured to receive a request from a Web client that executes a Single Page Application by means of a Web API, execute a process corresponding to the request received by the Web API to the robot 2, and generate a response to the request as update data of the Single Page Application.

Single Page Application (hereinafter, referred to as SPA) is a method for constructing Web applications. In the SPA, the Web page is not generated by the server after the activation of the Web application, and the Web page is updated in the Web application based on data acquired from the server.

The Web client is, for example, a Web browser. The Web client may be a native application having a browsing function. The Web API is an API (Application Programming Interface) available by HTTP. The API is an interface for allowing an external application to use software provided in advance.

According to the robot controller 100, the user interface can be made into a Web application. Thus, the user interface can be updated at any time without being restricted by the hardware configuration of the terminal 200, and the user operability can be improved. On the other hand, since real-time control is required for the robot controller 100, resources that can be allocated to requests from Web applications in the robot controller 100 are limited.

On the other hand, according to the configuration in which a request is received from the Web client that executes the SPA and a response to the request is generated as the update data of the SPA, it is not necessary to generate a Web page in the robot controller 100 every time a request is made, and screen transition based on the response can be performed in the Web client. Therefore, the resources of the terminal 200 can be effectively utilized, and both the real-time performance in the robot controller 100 and the excellent operation feeling by timely screen transition can be achieved.

Further, since the request is received by the Web API, the type, format and the like of the request received by the robot controller 100 are limited to the range of the Web API. Therefore, even when the robot controller 100 is controlled by various terminals 200, robustness of the robot controller 100 can be maintained. Therefore, the robot controller 100 is effective for improving the operability of the robot 2.

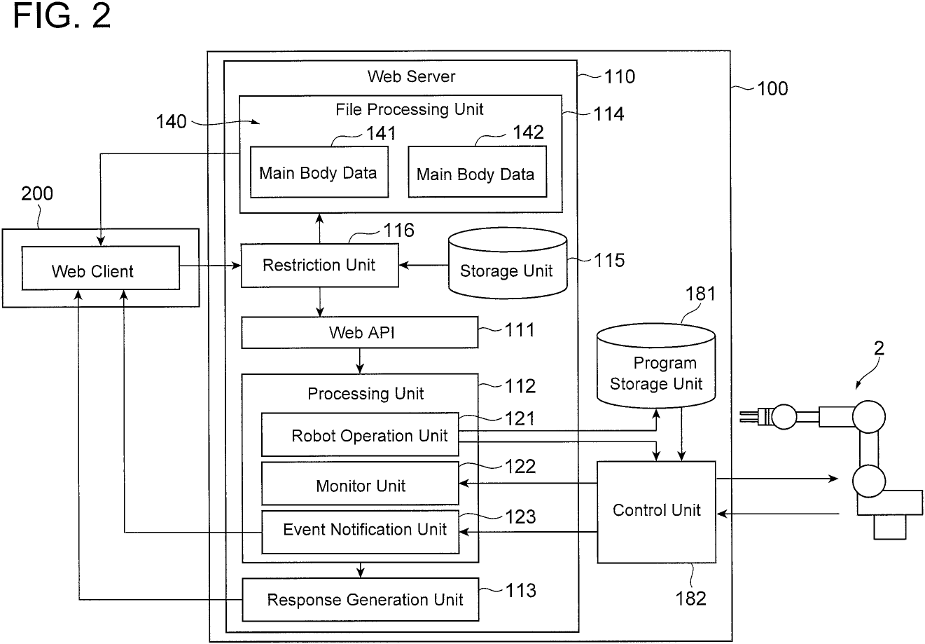

FIG. 2 is a block diagram illustrating the configuration of the robot controller 100. As shown in FIG. 2, the robot controller 100 includes a program storage unit 181 and a control unit 182 as components (hereinafter referred to as “blocks”). The program storage unit 181 stores an operation program generated by teaching. The control unit 182 sequentially calls a plurality of operation commands of the operation program stored in the program storage unit 181, and operates the robot 2 based on the operation commands. For example, the control unit 182 repeats control processing in a fixed control cycle. The control processing includes calculating the respective target angles of the joint 31, 32, 33, 34, 35, 36 so as to move the distal end portion 18 along an operation path represented by the target positions of a plurality of operation commands, and making the respective angles of the joint 31, 32, 33, 34, 35, 36 follow the target angles.

In order to enable the terminal 200 to operate the robot 2 in teaching, the robot controller 100 further includes a Web server 110. The Web server 110 receives a request from a Web client using HTTP (Hypertext Transfer Protocol) or the like, performs processing corresponding to the request, and transmits a response to the Web client. For example, the Web server 110 includes a file processing unit 114, a Web API 111, a processing unit (an example of “processing circuitry”) 112, and a response generation unit (an example of “response generation circuitry”) 113. The file processing unit 114 stores the main body data 140 of the SPA. The file processing unit 114 transmits the main body data 140 to the Web client in response to a request from the Web client.

The main body data 140 includes an HTML (Hypertext Markup Language) document written so as to display an operation interface on a Web client. Further, the main body data 140 may include one or more JavaScript (registered trademark) called from an HTML document in response to an operation to the operation interface.

The Web client executes the SPA (executes a Web application using the SPA) based on the main body data 140 transmitted by the file processing unit 114. As a result, the operation interface is displayed on the Web client.

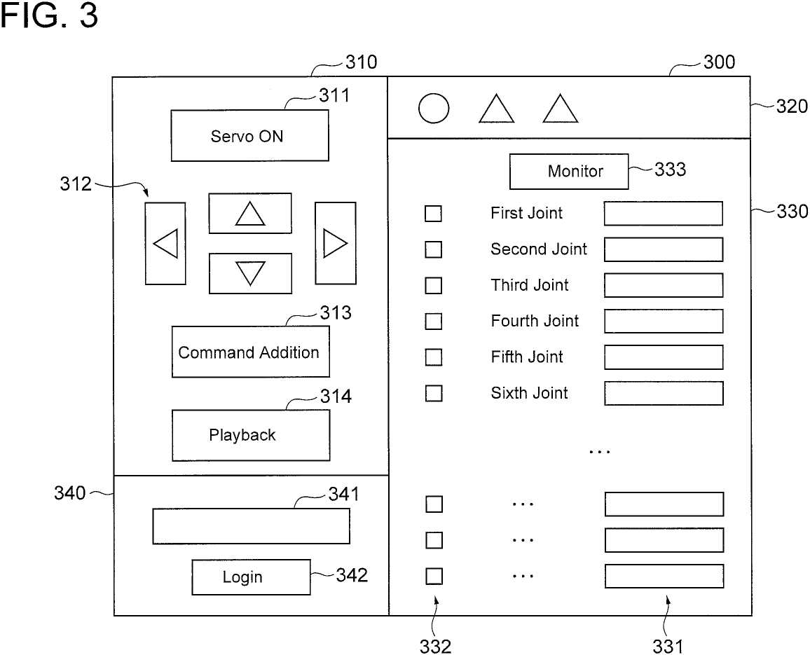

FIG. 3 is a schematic diagram illustrating an execution screen (operation interface) of the SPA in the Web client. The operation interface 300 shown in FIG. 3 has an operation window 310, an event window 320, a monitor window 330, and a login window 340. The operation window 310 includes a servo ON key 311, a jog key 312, a command addition key 313, and a playback key 314.

The servo ON key 311 is a software key for requesting servo ON. The Web client generates a servo-on request based on the user’s input to the servo ON key 311, and transmits it to the robot controller 100 via HTTP. In the servo ON request, the actuator 41, 42, 43, 44, 45, 46 is supplied with drive power (including power for stopping).

The jog key 312 is a software key for requesting a jog operation. The Web client generates a jog request based on the user’s input to the jog key 312, and transmits the robot controller 100 via HTTP. The jog request is a request to move the distal end portion 18 in a predetermined moving direction by a predetermined amount.

The command addition key 313 is a software key for requesting addition of an operation command. The Web client generates a command addition request based on the user’s input to the command addition key 313, and transmits it to the robot controller 100 via HTTP. The command addition request is a request to add an operation command for setting the current position of the distal end portion 18 as the target position to the operation program.

The playback key 314 is a software key for requesting to operate the robot 2 based on the operation program. Based on the user’s input to the playback key 314, the Web client generates a playback request and transmits it to the robot controller 100 via HTTP. The playback request is a request to operate the robot 2 based on a plurality of operation commands of the operation program stored in the program storage unit 181.

The event window 320 is a window for displaying the occurrence of an event related to the robot 2. The monitor window 330 is a window for displaying the status of the robot 2. For example, the monitor window 330 includes a plurality of status display units 331, a plurality of target selection units 332 respectively corresponding to the plurality of status display units 331, and monitor keys 333. The plurality of status display units 331 are boxes for displaying the statuses of a plurality of items related to the robot 2. Each of the plurality of target selection units 332 is a box for inputting whether or not monitoring of the corresponding status display unit 331 is necessary.

The monitor key 333 is a software key for requesting that the status of an item required to be monitored by the plurality of target selection units 332 be displayed on the plurality of status display units 331. Based on the user’s input to the monitor key 333, the Web client generates a monitoring request and transmits it to the robot controller 100 via HTTP. The monitoring request is a request to transmit data indicating the status of the robot 2.

The login window 340 has an ID input box 341 and a login key 342. The ID input box 341 is a box for inputting user identification information identification information. The login key 342 is a software key for requesting authentication of the identification information entered in the ID input box 341. The Web client generates an operation permission request including the identification information of the user based on the input to the login key 342 by the user and transmits the request to the robot controller 100 via HTTP. The operation permission request is a request to permit the user having the identification information input to the ID input box 341 to input an operation into the operation window 310.

Returning to FIG. 2, the Web API 111 receives requests from the Web client that executes the SPA. For example, the Web API 111 receives a request transmitted from a Web client via HTTP based on an input to the operation interface 300.

The processing unit 112 executes processing for the robot 2 in response to a request received by the Web API 111. For example, the processing unit 112 includes a robot operation unit (an example of “robot operation circuitry”) 121 and a monitor unit (an example of “monitor circuitry”) 122. The robot operation unit 121 executes an operation of the robot 2 in response to a request received by the Web API 111.

For example, the robot operation unit 121 turns on the servo in response to the servo ON request described above. For example, the robot operation unit 121 provides the actuator 41, 42, 43, 44, 45, 46 with driving power (including power for stopping the actuator).

The robot operation unit 121 causes the control unit 182 to operate the robot 2 in response to a request. For example, the robot operation unit 121 causes the control unit 182 to move the distal end portion 18 in the moving direction and the moving amount indicated by the jog request described above. In response to the playback request described above, the robot operation unit 121 causes the control unit 182 to operate the robot 2 based on a plurality of operation commands of the operation program stored in the program storage unit 181.

The operation of the robot 2 is not necessarily limited to the operation for operating the robot 2. Addition, deletion, or change of data for operating the robot 2 is also included in the operation of the robot 2. For example, adding a new operation program to the program storage unit 181, deleting an operation program stored in the program storage unit 181, or editing an operation program stored in the program storage unit 181 are included in the operation of the robot 2. Further, addition, deletion, or change of control parameters for operating the robot 2 is also included in the operation of the robot 2. For example, in response to the command addition request described above, the robot operation unit 121 adds an operation command for setting the current position of the distal end portion 18 as the target position to the operation program stored in the program storage unit 181.

The monitor unit 122 monitors the robot 2 in response to a request. For example, the monitor unit 122 monitors the status of the robot 2 in response to the monitoring request described above. As an example of the status of the robot 2, the angle of each joint 31, 32, 33, 34, 35, 36 can be given. The status of the robot 2 includes the status of the robot controller 100 that controls the robot 2. Examples of the status of the robot controller 100 include the values of the control parameters described above.

The response generation unit 113 generates a response to the request as update data of the SPA. The update data of the SPA is data used to update the display contents in the displayed Web page. The response generation unit 113 transmits the generated response to the Web client. For example, the response generation unit 113 transmits a response to the port of the Web client specified in the request. The Web client partially updates the display of the execution screen in response to the response.

For example, when the robot operation unit 121 executes an operation of the robot 2, the response generation unit 113 generates a response including a notification of completion of the operation and transmits it to the Web client. Based on the response indicating the completion of the operation, the Web client updates the display of the operation window 310 so as to indicate the completion of the operation.

When the robot operation unit 121 executes monitoring of the robot 2, the response generation unit 113 generates a response including a monitoring completion notification and a monitoring result, and transmits the response to the Web client. The Web client updates the display of the monitor window 330 described above to show the result of the monitoring.

The processing unit 112 may further include an event notification unit (an example of “event notification circuitry”) 123. The event notification unit 123 monitors the occurrence of an event in the robot controller 100, and when an event occurs, notifies the Web client of the occurrence of the event by Server-Sent Events. Server-Sent Events (hereinafter referred to as SSE) is a method for performing PUSH communication from a Web server to a client. In the SSE, a channel for event notification is established in response to a request from a Web client, and the channel is maintained after a response to the request is generated and sent.

As an example, the Web client generates an event monitoring request in response to activation of the SPA, and transmits it to the robot controller 100 via HTTP. An event monitor request is a request for notification of an event by the SSE. In response to the event monitoring request, the event notification unit 123 establishes a channel with the Web client for notification of an event related to the robot 2. Hereinafter, the established channel is referred to as an “event notification channel”. For example, the event notification unit 123 stores the identification information of the port designated in the event monitoring request. Hereinafter, the port on which the identification information is stored is referred to as an event notification port.

When the event notification unit 123 establishes an event notification channel, the response generation unit 113 transmits a response to the event monitoring request. After receiving the response, the Web client keeps the event notification port open. The event notification unit 123 transmits notification data for notifying the occurrence of an event to the event notification port based on the stored identification information. The Web client causes the event window 320 to display the occurrence of the event based on the notification data.

As an example of an event related to the robot 2, an occurrence of an abnormality in the robot 2 can be given. The event related to the robot 2 may include an alarm generated by the robot controller 100 based on an abnormality in the robot 2. For example, the event notification unit 123 monitors whether or not an alarm has occurred in the control unit 182, and when an alarm has occurred in the control unit 182, transmits data for notification of occurrence of the alarm to the event notification port.

Specific examples of the abnormality in the robot 2 include occurrence of an overcurrent with respect to the actuator 41, 42, 43, 44, 45, 46, deviation of the angle of the joint 31, 32, 33, 34, 35, 36 from the movable range, occurrence of abnormal torque in the actuator 41, 42, 43, 44, 45, 46, disconnection of a cable between the robot controller 100 and the actuator 41, 42, 43, 44, 45, 46, and the like.

By applying the SSE to the alarm, both reduction of the communication load and timely notification of the alarm can be achieved. Although the alarm itself is required to be notified in a timely manner, it is not an event that occurs constantly. Therefore, by applying the SSE to the alarm, the reduction of the communication load becomes more remarkable.

When the Web API receives a batch request including a plurality of requests, the processing unit 112 may execute a batch process including a plurality of processes corresponding to a plurality of requests and a batch process, and the response generation unit 113 may generate a response to the batch request. Without repeating requests and responses between the Web client and the robot controller 100, a plurality of processes can be collectively executed by the processing unit 112. Thus, the communication load between the Web client and the robot controller 100 can be further reduced, and the operation feeling can be further improved.

The Web client generates a batch request including a plurality of requests based on an input to the execution screen of the SPA, and transmits the batch request to the robot controller 100 by HTTP. As an example, the Web client generates a batch request that includes a plurality of monitoring requests based on user input into the monitor window 330. For example, when an operation of pressing the monitor key 333 is performed, the Web client specifies two or more items requiring monitoring based on inputs to the plurality of target selection units 332, and generates a batch request including two or more monitoring requests corresponding to the two or more items, respectively.

The processing unit 112 causes the monitor unit 122 to execute a batch process including two or more monitoring corresponding to two or more monitoring requests. The response generation unit 113 transmits the response to the batch process including the results of two or more monitoring to the Web client.

In the batch processing, the processing unit 112 may execute a first process corresponding to a first request included in a plurality of requests, and execute a second process corresponding to a second request included in a plurality of requests using a result of the first process as an argument.

As an example of the first process, one or more operation commands for operating the robot 2 in a path adapted to the surrounding environment are generated. As an example of the second process, the robot 2 is operated based on one or more operation commands generated by the first process.

It is also possible to cause the processing unit 112 to collectively execute a plurality of processes including the transfer of the process result between the first process and the second process. Thus, the communication load between the Web client and the robot controller 100 can be further reduced, and the operation feeling can be further improved.

The robot controller 100 may be configured to limit the operation of the robot 2 by the Web client based on the user identification information. For example, the Web server 110 may further include a storage unit (an example of “storage”) 115 and a restriction unit (an example of “restriction circuitry”) 116. The storage unit 115 stores user identification information. The restriction unit 116 restricts the operation of the robot 2 by the robot operation unit 121 when the identification information of the user of the Web client is not stored in the storage unit 115. For example, the restriction unit 116 prohibits the robot 2 from being operated by the robot operation unit 121.

In the Web client, user information is acquired by login information or the like inputted by the user. The user identification information is included in, for example, the body of the POST method in the request. The restriction unit 116 determines whether or not the user identification information included in the received data of the request received by the Web API 111 is stored in the storage unit 115.

As an example, the Web client includes a user identification method in a request for operating the robot 2 by the robot operation unit 121 (hereinafter referred to as “operation request”). The restriction unit 116 determines whether or not the user identification information is stored in the storage unit 115 based on the user identification information included in the received data of the operation request.

The Web client may be configured to invalidate an operation object (e.g., operation window 310) for transmitting an operation request when the user identification information is not authenticated. For example, the Web client displays the execution screen of the SPA in a state in which the operation object for transmitting the operation request (for example, the operation window 310) is invalidated. When the login information is input by the user (for example, when the login key 342 is pressed), the Web client transmits the above-described operation permission request including the identification information of the user. The restriction unit 116 determines whether or not the user identification information included in the received data of the operation permission request is stored in the storage unit 115.

The response generation unit 113 transmits a response including the determination result by the restriction unit 116. For example, when it is determined that the user identification information is stored in the storage unit 115, the response generation unit 113 transmits a response including “operation permission” as a determination result. When it is determined that the user identification information is not stored in the storage unit 115, the response generation unit 113 transmits a response including “operation prohibited” as a determination result.

When the response including “operation permission” is acquired, the Web client makes the operation window 310 effective. When a response including “operation prohibited” is acquired, the Web client keeps the operation window 310 invalidated. Since transmission of an operation request is prohibited by keeping the operation window 310 invalid, the operation of the robot 2 by the robot operation unit 121 is restricted.

The Web client may transmit a user authentication request before the display of the execution screen of the SPA, enable the operation object and display the execution screen of the SPA when a response including “operation permission” is acquired, and disable the operation object and display the execution screen of the SPA when a response including “operation prohibition” is acquired.

Web applications allow requests to include information about users who are logged into the web application. The robustness of the robot controller 100 can be further improved by limiting the operation of the robot 2 by robot 2 by the user who does not store the identification information.

The robot controller 100 may be configured to limit the operation of the robot 2 by the Web client based on the transmission path of the request. For example, when the Web client transmits a request via the communication network, the restriction unit 116 may restrict the operation of the robot 2 by the robot operation unit 121. For example, the restriction unit 116 prohibits the robot 2 from being operated by the robot operation unit 121.

For example, the restriction unit 116 determines whether or not the request has been transmitted via the communication network based on information included in the received data of the request. As an example, the Web client determines whether or not the operation request is transmitted via the communication network based on information included in the reception data of the operation request.

The restriction unit 116 may determine whether or not the operation permission request is transmitted via the communication network based on information included in the received data of the operation permission request. The response generation unit 113 transmits a response including the determination result by the restriction unit 116. For example, when it is determined that the operation permission request has been transmitted without via the communication network, the response generation unit 113 transmits a response including “operation permission” as a determination result. When it is determined that the operation permission request has been transmitted via the communication network, the response generation unit 113 transmits a response including “operation prohibition” as a determination result.

Similar to the restriction based on the user identification information described above, the Web client validates the operation window 310 when a response including “operation permission” is acquired, and invalidates the operation window 310 when a response including “operation prohibition” is acquired. Whether or not to enable the operation window 310 may be determined either before or after the execution screen of the SPA is displayed.

According to the Web application, it is also possible to remotely access the robot controller 100 via a communication network. On the other hand, under remote access, there is a possibility that the robot 2 is operated in a situation where visual confirmation by the user is insufficient. On the other hand, when a request is received via a communication network, by limiting the operation of the robot 2, both convenience of remote access and robustness of the robot controller 100 can be achieved.

The restriction unit 116 may restrict the operation of the robot 2 by the robot operation unit 121 both when the identification information of the user of the Web client is not stored in the storage unit 115 and when the Web client transmits a request via the communication network.

The robot controller 100 may be configured to restrict the operation of the robot 2 by the Web client based on the identification information of the terminal 200. For example, the storage unit 115 may store the identification information of the terminal 200. The restriction unit 116 may restrict the operation of the robot 2 by the robot operation unit 121 when the identification information of the terminal 200 that executes the Web client is not stored in the storage unit 115. For example, the restriction unit 116 prohibits the robot 2 from being operated by the robot operation unit 121.

For example, the restriction unit 116 acquires the identification information of the terminal 200 based on the information included in the received data of the request, and determines whether or not the acquired identification information is stored in the storage unit 115. As an example, the restriction unit 116 may determine whether or not the identification information acquired based on the information included in the received data of the operation request is stored in the storage unit 115.

The restriction unit 116 may determine whether or not the identification information acquired based on the information included in the received data of the operation permission request is stored in the storage unit 115. The response generation unit 113 transmits a response including the determination result by the restriction unit 116. For example, when it is determined that the identification information of the terminal 200 is stored in the storage unit 115, the response generation unit 113 transmits a response including “operation permission” as a determination result. When it is determined that the identification information of the terminal 200 is not stored in the storage unit 115, the response generation unit 113 transmits a response including “operation prohibited” as a determination result.

Similar to the restriction based on the user identification information described above, the Web client validates the operation window 310 when a response including “operation permission” is acquired, and invalidates the operation window 310 when a response including “operation prohibition” is acquired. Whether or not to enable the operation object may be determined before or after the display of the execution screen of the SPA.

By restricting the operation of the robot 2 from the terminal 200 in which the identification information is not stored in the storage unit 115, it is possible to achieve both the convenience of being able to use various terminals 200 and the robustness of the robot controller 100.

The restriction unit 116 may restrict the operation of the robot 2 by the robot operation unit 121 both when the identification information of the user of the Web client is not stored in the storage unit 115 and when the identification information of the terminal 200 is not stored in the storage unit 115. The restriction unit 116 may restrict the operation of the robot 2 by the robot operation unit 121 both when the Web client transmits a request via the communication network and when the identification information of the terminal 200 is not stored in the storage unit 115. The restriction unit 116 may restrict the operation of the robot 2 by the robot operation unit 121 in all cases where the identification information of the user of the Web client is not stored in the storage unit 115, where the Web client transmits a request via the communication network, and where the identification information of the terminal 200 is not stored in the storage unit 115.

The robot controller 100 may be configured to change the main body data of the SPA to be transmitted to the Web client in response to a request from the Web client. For example, the file processing unit 114 is connected to the main body data 140 (hereinafter referred to as “main body data 141”) of the SPA capable of transmitting a monitoring request. SPA main body data 140 (hereinafter referred to as “main body data 142”) capable of transmitting a request for operation of the robot 2 in addition to a request for monitoring. A plurality of types of main body data 140 may be stored. In the SPA based on the body data 141, the request for operation of the robot 2 is at least partially limited. The file processing unit 114 may transmit any one of a plurality of types of main body data 140 to the Web client in response to a request from the Web client.

As an example, the file processing unit 114 may transmit the main body data 142 when the user identification information included in the received data of the request is not stored in the storage unit 115, and may transmit the main body data 141 when the user identification information included in the received data of the request is stored in the storage unit 115. The file processing unit 114 may transmit the main body data 141 when the request is transmitted via the communication network, and may transmit the main body data 142 when the request is transmitted without the communication network. The file processing unit 114 may transmit the main body data 141 when the identification information of the terminal 200 is not stored in the storage unit 115, and may transmit the main body data 142 when the identification information of the terminal 200 is stored in the storage unit 115.

The file processing unit 114 may select the main body data 140 to be transmitted based on both the user identification information included in the request and the transmission path of the request. The file processing unit 114 may select the main body data 140 to be transmitted based on both the identification information of the user included in the request and the identification information of the terminal 200 included in the request. The restriction unit 116 may select the main body data 140 to be transmitted based on both the transmission path of the request and the identification information of the terminal 200 included in the request. The file processing unit 114 may select the main body data 140 to be transmitted based on all of the user identification information included in the request, the transmission path of the request, and the identification information of the terminal 200 included in the request.

On the basis of the transmission request of the main body data 140, the restriction unit 116 may determine whether to make “operation permission” or “operation prohibition”, and may cause the file processing unit 114 to transmit the operation main body data 142 as a response including the “operation permission”, and cause the file processing unit 114 to transmit the monitor main body data 141 as a response including the “operation prohibition”.

By selectively using a plurality of types of main body data 140 in response to a request from a Web client, it is possible to change the display of the Web application according to the difference between users, the difference between terminals 200, the difference between access paths, or the like, and to further improve the operation feeling.

### Hardware Configuration

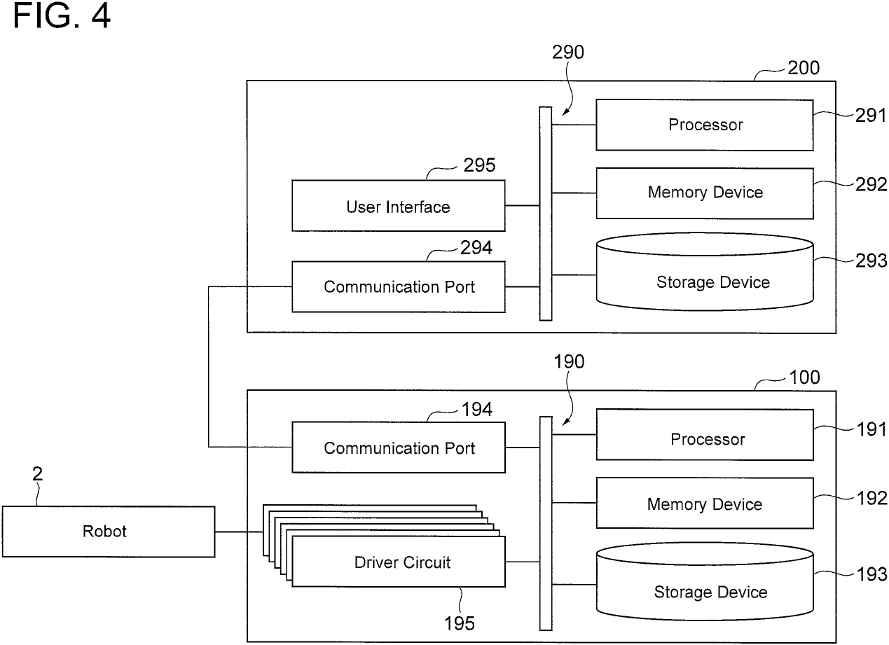

FIG. 4 is a block diagram illustrating a hardware configuration of a control system including a robot controller 100 and a terminal 200. The robot controller 100 has a circuit 190. The circuit 190 includes one or more processors 191, one or more memory devices 192, one or more storage unit devices 193, a communication port 194, and a driver circuit 195. One or more storage unit devices 193 store a program for causing the robot controller 100 to receive a request from a Web client that executes an SPA by means of a Web API, execute a process corresponding to the request received by the Web API to the robot 2, and generate a response to the request as update data of the SPA. For example, one or more storage unit devices 193 store programs for causing the robot controller 100 to configure each of the above-described blocks. Each of the one or more storage unit devices 193 may be a built-in storage unit medium such as a flash memory or a hard disk, or may be a portable storage unit medium such as a USB memory or an optical disk.

One or more memory devices 192 temporarily stores a program loaded from one or more storage unit devices 193. Each of the one or more memory devices 192 may be a random access memory or the like. The one or more processors 191 constitute each of the above-described blocks by executing programs loaded in the one or more memory devices 192. The one or more processors 191 store the calculation results in the one or more memory devices 192 as appropriate.

The communication port 194 communicates with the terminal 200 based on a request from one or more processors 191. The driver circuit 195 supplies drive power to the robot 2 (actuator 41, 42, 43, 44, 45, 46) based on a request from one or more processors 191.

The terminal 200 has a circuit 290. The circuit 290 includes one or more processors 291, one or more memory devices 292, one or more storage unit devices 293, a communication port 29, and a user interface 295. The one or more storage unit devices 293 are non-volatile storage unit media and store at least an operating system and an execution program of the Web client. Each of the one or more storage unit devices 293 may be a built-in storage unit medium such as a flash memory or a hard disk, or may be a portable storage unit medium such as a USB memory or an optical disk.

One or more memory devices 292 temporarily stores a program loaded from one or more storage unit devices 293. The one or more memory devices 292 may be random access memories or the like. One or more processors 291 execute programs loaded into one or more memory devices 292. The one or more processors 291 store the calculation results in the one or more memory devices 292 as appropriate.

The communication port 294 communicates with the robot controller 100 based on a request from one or more processors 291. User interface 295 communicates with the user based on requests from one or more processors 291. For example, the user interface 295 includes a display device and an input device. Examples of the display device include a liquid crystal monitor, an organic EL (Electro-Luminescence) monitor, and the like. Examples of the input device include a keyboard, a mouse, a keypad, and the like. The input device may be integrated with the display device as a touch panel.

The hardware configuration described above is merely an example, and can be changed as appropriate.

### Control Method

As an example of the control method, a control procedure executed by the robot controller 100 will be illustrated. The control procedure includes receiving a request from a Web client that executes the SPA by means of the Web API, executing a process corresponding to the request received by the Web API to the robot 2, and generating a response to the request as update data of the SPA. In the following description, a more detailed control procedure is divided into an SPA start-up procedure, a request handling procedure, and an event monitoring procedure.

### (SPA Boot Procedure)

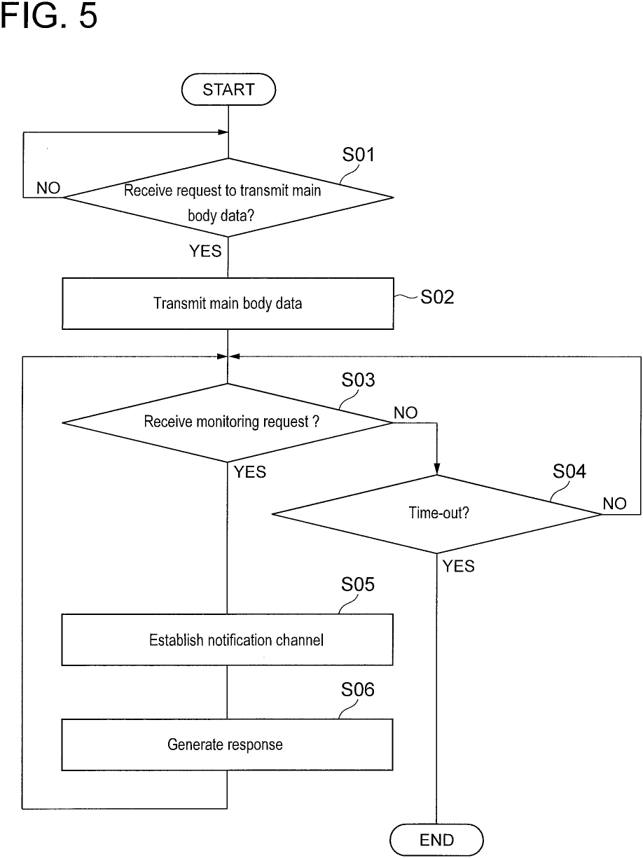

As shown in FIG. 5, the robot controller 100 first executes steps S01 and S02. In step S01, the file processing unit 114 waits for a request to transmit main body data of the SPA. In step 02, the file processing unit 114 transmits the main body data 140 to the Web client. The Web client executed by the terminal 200 executes the SPA based on the main body data 140 transmitted by the file processing unit 114. For example, the Web client generates the operation interface 300 in a state where the operation window 310 is invalidated.

Next, the robot controller 100 executes step S03. In step 03, the event notification unit 123 confirms whether or not the event monitoring request has been received by the Web API 111. If it is determined in step 03 that the event monitoring request has not been received, the robot controller 100 executes step 04. In step 04, it is confirmed whether or not a predetermined startup standby time has elapsed. If it is determined in step 04 that the startup standby time has not elapsed, the robot controller 100 returns the process to step 03.

When it is determined in step 03 that the event monitoring request has been received, the robot controller 100 executes steps 05 and 06. In step 05, the event notification unit 123 establishes an event notification channel with the Web client. In step 06, the response generation unit 113 generates a response to the event monitoring request and transmits the response to the Web client. Thereafter, the robot controller 100 returns the process to step 03. Thereafter, until the activation waiting time elapses, an event notification channel for each event is established every time an event monitoring request is received.

In step 04, when the startup standby time is completed, the startup of the SPA is completed.

### (Handling Procedures for Requests)

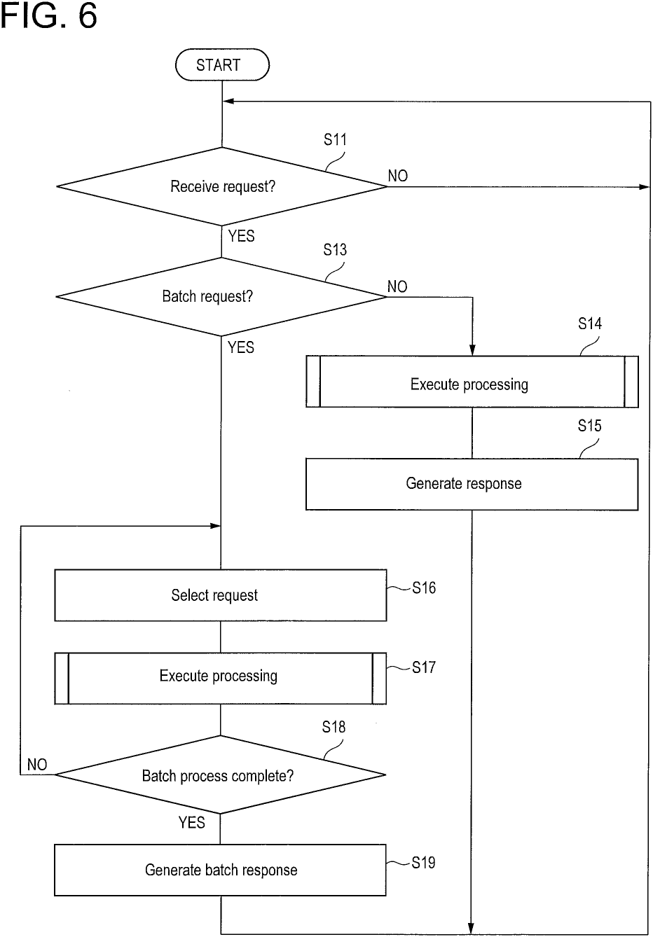

As shown in FIG. 6, the robot controller 100 first executes step S11. In step S11, the processing unit 112 waits for reception of a request by the Web API 111. If it is determined in step S11 that the request has been received, the robot controller 100 executes step S13. In step S13, the processing unit 112 confirms whether or not the request is a batch request. If it is determined in step S13 that the request is not a batch request, the robot controller 100 executes steps S14 and S15. In step S14, the processing unit 112 executes processing corresponding to the request. The contents of step S14 will be described later. In step S15, the response generation unit 113 generates a response to the request as the update data of the SPA and transmits the response to the request to the Web client.

If it is determined in step S13 that the request is a batch request, the robot controller 100 executes steps S16, S17, and S18. In step S16, the processing unit 112 selects an unhandled request from among a plurality of requests included in the batch request. In step S17, the processing unit 112 executes processing corresponding to the request. The contents of step S14 will be described later. In step S18, the processing unit 112 confirms whether or not processing (batch processing) corresponding to all requests included in the batch request has been completed. If it is determined in step S18 that the batch process has not been completed, the robot controller 100 returns the process to step S16. Thereafter, the selection of the request and the processing corresponding to the selected request are repeated until the batch processing is completed.

If it is determined in step S18 that the batch process has been completed, the robot controller 100 executes step S19. In step S19, the response generation unit 113 generates a response to the batch request as the update data of the SPA and transmits it to the Web client.

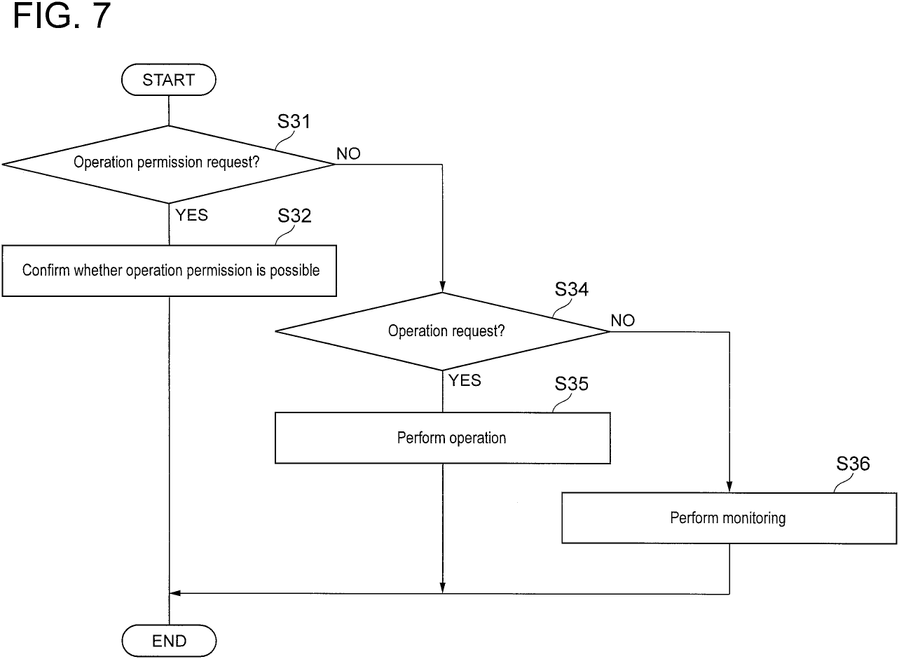

FIG. 7 is a flowchart illustrating the processing procedure in steps S14 and S17. As shown in FIG. 7, the robot controller 100 first executes step S31. In step S31, the processing unit 112 confirms whether or not the request is an operation permission request. If it is determined in step S31 that the request is an operation permission request, the robot controller 100 executes step S32.

In step S32, the processing unit 112 causes the restriction unit 116 to confirm whether or not the operation permission is possible. On the basis of whether or not the user identification information included in the received data of the operation permission request is stored in the storage unit 115, the restriction unit 116 confirms whether or not the operation permission is possible. As described above, the restriction unit 116 may check whether the operation permission is possible based on whether the transmission path of the operation permission request includes the communication network. The restriction unit 116 may confirm whether the operation permission is possible based on whether the identification information of the terminal 200 is stored in the storage unit 115.

When it is determined that the operation permission is possible, the restriction unit 116 includes “operation permission” in the response transmitted by the response generation unit 113. When it is determined that the operation permission is impossible, the restriction unit 116 includes “operation prohibition” in the response transmitted by the response generation unit 113. When the response including “operation permission” is acquired, the Web client makes the operation window 310 effective. When a response including “operation prohibited” is acquired, the Web client keeps the operation window 310 invalidated.

If it is determined in step S31 that the request is not an operation permission request, the robot controller 100 executes step S34. In step S34, the processing unit 112 confirms whether or not the request is an operation request. If it is determined in step S34 that the request is an operation request, the robot controller 100 executes step S35. In step S35, the robot operation unit 121 performs the operation of the robot 2 in response to the request. If it is determined in step S34 that the request is not an operation request (i.e., a monitoring request), the robot controller 100 executes step S36. In step S36, the monitor unit 122 monitors the robot 2 in response to the request. The monitor unit 122 includes the monitoring result in the response transmitted by the response generation unit 113. Thus, the processing procedure is completed.

### (Event Monitoring Procedure)

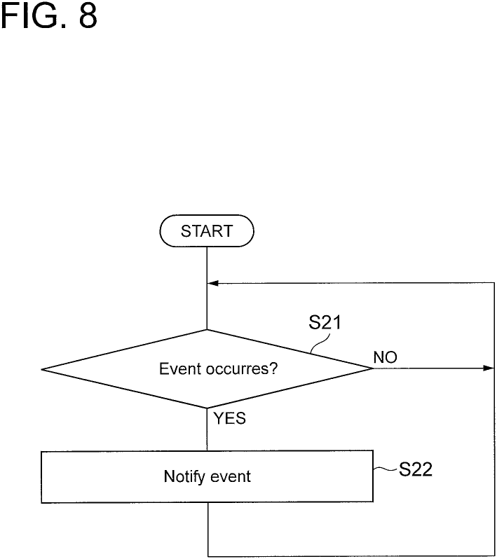

The event monitoring procedure is a procedure performed in parallel with the above-described request handling procedure after the establishment of the event notification channel in step 05. As shown in FIG. 8, the robot controller 100 executes steps S21 and S22. In step S21, the event notification unit 123 waits for occurrence of an event. In step S22, the event notification unit 123 transmits notification data of the event to the event notification port. Thereafter, the robot controller 100 returns the process to step S21. Thereafter, monitoring continues.

### Summary

As described above, the robot controller 100 includes a Web API 111 for receiving a request from a Web client for executing a Single Page Application, a processing unit 112 for executing a process corresponding to the request received by the Web API 111 to the robot 2, and a response generation unit 113 for generating a response to the request as Single Page Application update data.

According to the robot controller 100, the operation interface of the robot 2 can be made into a Web application. Thus, the operation interface can be updated at any time without being restricted by the hardware configuration of the terminal 200, and the user’s operability can be improved. On the other hand, since real-time control is required for the robot controller 100, resources that can be allocated to requests from Web applications in the robot controller 100 are limited.

On the other hand, according to the configuration in which a request is received from the Web client that executes the SPA and a response to the request is generated as the update data of the SPA, it is not necessary to generate a Web page in the robot controller 100 every time a request is made, and screen transition based on the response can be performed in the Web client. Therefore, the resources of the terminal 200 can be effectively utilized, and both the real-time performance in the robot controller 100 and the excellent operation feeling by the timely screen transition can be achieved. Therefore, it is effective for improving the operability of the robot 2.

Further, since the request is received by the Web API 111, the type, format, etc. of the request received by the robot controller 100 are limited to the range of the Web API 111. Therefore, even when the robot controller 100 is controlled by various terminals 200, robustness of the robot controller 100 can be maintained.

It may further include a file processing unit 114 that stores the main body data 140 of the Single Page Application and transmits it to the Web client in response to a request. Since it is not necessary to store the main body data 140 of the Single Page Application in advance in the terminal 200, various terminals 200 can be used for the operation of the robot 2 only by connecting to the robot controller 100.

The processing unit 112 may include an event notification unit 123 that monitors the occurrence of an event in the robot controller 100 and notifies the Web client of the occurrence of the event by the Server-Sent Events when the event occurs. Without repeating requests and responses between the Web client and the robot controller 100, it is possible to notify the Web client of the occurrence of the event in a timely manner. Thus, the communication load between the Web client and the robot controller 100 can be further reduced, and the operation feeling can be further improved.

The event may include an alarm that occurs in the robot controller 100. By applying the SSE to the alarm, both reduction of the communication load and timely notification of the alarm can be achieved. Although the alarm itself is required to be notified in a timely manner, it is not an event that occurs constantly. Therefore, by applying the SSE to the alarm, the reduction of the communication load becomes more remarkable.

The processing unit 112 may include a robot operation unit 121 that executes an operation of the robot 2 in response to a request, and a monitor unit 122 that monitors the robot 2 in response to a request. The processing unit 112 can provide services for both the operation of the robot 2 and the monitoring of the robot 2, thereby further improving the usability.

The device may further comprise a storage unit 115 for storing user identification information, and a restriction unit 116 for restricting the operation of the robot 2 by the robot operation unit 121 when the Web API 111 receives a request including the user identification information not stored in the storage unit 115. Web applications allow requests to include information about users who are logged into the web application. The robustness of the robot controller 100 can be further improved by limiting the operation of the robot 2 by robot 2 by the user who does not store the identification information.

When the Web API 111 receives a request via a communication network, the robot control apparatus may further include a restriction unit 116 that restricts the operation of the robot 2 by the robot operation unit 121. According to the Web application, it is also possible to remotely access the robot controller 100 via a communication network. On the other hand, under remote access, there is a possibility that the robot 2 is operated in a situation where visual confirmation by the user is insufficient. On the other hand, when a request is received via a communication network, by limiting the operation of the robot 2, both convenience of remote access and robustness of the robot controller 100 can be achieved.

The device may further comprise a storage unit 115 for storing identification information of a terminal 200 that executes a Web client, and a restriction unit 116 for restricting the operation of the robot 2 by the robot operation unit 121 when the Web API 111 receives a request from a terminal 200 that does not store the identification information in the storage unit 115. By restricting the operation of the robot 2 from the terminal 200 in which the identification information is not stored in the storage unit 115, it is possible to achieve both the convenience of being able to use various terminals 200 and the robustness of the robot controller 100.

When the Web API 111 receives a batch request including a plurality of requests, the processing unit 112 may execute a batch process including a plurality of processes corresponding to the plurality of requests, and the response generation unit 113 may generate a response to the batch request. Without repeating requests and responses between the Web client and the robot controller 100, a plurality of processes can be collectively executed by the processing unit 112. Thus, the communication load between the Web client and the robot controller 100 can be further reduced, and the operation feeling can be further improved.

In the batch processing, the processing unit 112 may execute a first process corresponding to a first request included in a plurality of requests, and execute a second process corresponding to a second request included in a plurality of requests using a result of the first process as an argument. It is also possible to cause the processing unit 112 to collectively execute a plurality of processes including the transfer of the process result between the first process and the second process. Thus, the communication load between the Web client and the robot controller 100 can be further reduced, and the operation feeling can be further improved.

The file processing unit 114 may store a plurality of types of main body data 140 including a Single Page Application main body data 140 capable of transmitting a request for monitoring the robot 2 and a Single Page Application main body data 140 capable of transmitting a request for operation of the robot 2 in addition to the request for monitoring, and may transmit any of the plurality of types of main body data 140 to the Web client in response to a request from the Web client. By selectively using a plurality of types of main body data 140 according to a request from a Web client, the display of the Web application can be changed according to differences in users, differences in terminals 200, differences in access paths, and the like, and the operational feeling can be further improved.

The Web client may generate a request based on the input to the execution screen of the Single Page Application and partially update the display of the execution screen in response to the response. Since the screen transition based on the response is performed in the Web client, it is not necessary to generate a Web page in the robot controller 100 every time a request is made. Therefore, the resources of the terminal 200 can be effectively utilized, and both the real-time performance in the robot controller 100 and the excellent operation feeling by the timely screen transition can be achieved.

The Web client may generate a request for event monitoring in response to the activation of the Single Page Application, and the robot controller 100 may further have an event notification unit 123 which starts monitoring the occurrence of an event in the robot controller 100 when the Web API 111 receives the request for event monitoring and notifies the Web client of the occurrence of the event by the Server-Sent Events when the event occurs. The communication load after the activation of the SPA can be further reduced.

A batch request including a plurality of requests may be generated based on an input to the execution screen, the processing unit 112 may execute a batch process including a plurality of processes corresponding to the plurality of requests when the Web API 111 receives the batch request, and the response generation unit 113 may generate a response to the batch process. By dynamically generating a batch request based on an input of an operator, it is possible to achieve both reduction of communication load and reduction of useless processing.

Although the embodiments have been described above, the present disclosure is not necessarily limited to the embodiments described above, and various modifications can be made without departing from the gist thereof.

The term “comprise” and its variations are intended to mean open-ended terms, not excluding any other elements and/or components that are not recited herein. The same applies to the terms “include”, “have”, and their variations.

The component suffixed with a term such as “member”, “portion”, “part”, “element”, “body”, and “structure” is intended to mean that there is a single such component or a plurality of such components.

Ordinal terms such as “first” and “second” are merely used for distinguishing purposes and there is no other intention (such as to connote a particular order) in using ordinal terms. For example, the mere use of “first element” does not connote the existence of “second element”; otherwise, the mere use of “second element” does not connote the existence of “first element”.

Approximating language such as “approximately”, “about”, and “substantially” may be applied to modify any quantitative representation that could permissibly vary without a significant change in the final result obtained. All of the quantitative representations recited in the present application shall be construed to be modified by approximating language such as “approximately”, “about”, and “substantially”.

The phrase “at least one of A and B” is intended to be interpreted as “only A”, “only B”, or “both A and B”.

Obviously, numerous modifications and variations of the present disclosure are possible in light of the above teachings. It is therefore to be understood that within the scope of the appended claims, the present disclosure may be practiced otherwise than as specifically described herein.

What is claimed is:

1. A robot controller comprising:
a Web API (Application Programming Interface) configured to receive a request from a Web client which is configured to execute a Single Page Application;
processing circuitry configured to execute a process with respect to a robot, the process corresponding to the request received by the Web API; and
response generation circuitry configured to generate a response to the request as updated data for the Single Page Application.

2. The robot controller according to claim 1, further comprising:
a web server configured to store main body data of the Single Page Application and transmit the main body data to the Web client in response to the request.

3. The robot controller according to claim 1, wherein the processing circuitry has an event notification unit which is configured to monitor an occurrence of an event in the robot controller and configured to notify the Web client of the occurrence of the event via Server-Sent Events when the event occurs.

4. The robot controller according to claim 3, wherein the event includes an alarm generated in the robot controller.

5. The robot controller according to claim 1, wherein the processing circuitry comprises
robot operation circuitry configured to execute an operation of the robot in response to the request, and
monitor circuitry configured to execute monitoring of the robot in response to the request.

6. The robot controller according to claim 5, further comprising:
a storage configured to store user identification information; and
restriction circuitry configured to restrict the operation of the robot when the Web API receives the request including an identification information which is not stored in the storage.

7. The robot controller according to claim 5, further comprising:
a restriction circuitry configured to restrict the operation of the robot when the Web API receives the request via a communication network.

8. The robot controller according to claim 5, further comprising:
a storage configured to store identification information of a terminal that is configured to execute the Web client; and
restriction circuitry configured to restrict the operation of the robot when the Web API receives the request from a terminal whose identification information is not stored in the storage.

9. The robot controller according to claim 1,
wherein, when the Web API receives a batch request including a plurality of requests, the processing circuitry executes a batch process including a plurality of processes respectively corresponding to the plurality of requests, and
wherein the response generation circuitry generates responses to the plurality of requests, respectively.

10. The robot controller according to claim 9, wherein, in the batch processing, the processing circuitry is configured to execute a first process corresponding to a first request included in the plurality of requests, and is configured to execute a second process corresponding to a second request included in the plurality of requests using a result of the first process as an argument.

11. The robot controller according to claim 1, further comprising:
a web server configured to
store plurality of types of main body data comprising:
main body data of the Single Page Application capable of transmitting the request for monitoring the robot; and
main body data of the Single Page Application capable of transmitting the request for operation of the robot in addition to the request for monitoring, and
transmit any of the plurality of types of the main body data to the Web client in response to the request from the Web client.

12. A control system comprising:
a terminal configured to execute a Web client; and
a robot controller comprising:
a Web API (Application Programming Interface) configured to receive a request from a Web client which is configured to execute a Single Page Application;
processing circuitry configured to execute a process with respect to a robot,
the process corresponding to the request received by the Web API; and
response generation circuitry configured to generate a response to the request as updated data for the Single Page Application.

13. The control system according to claim 12, wherein the Web client is configured to
generate the request based on an input to the execution screen of the Single Page Application, and
partially update a display of the execution screen in response to the response.

14. The control system according to claim 13,
wherein the Web client is configured to generate the request for event monitoring in response to activation of the Single Page Application, and
wherein the robot controller further comprises event notification circuitry which is configured to start monitoring an occurrence of the event in the robot controller when the Web API receives the request for event monitoring, and which is configured to notify the Web client of the occurrence of the event by means of Server-Sent Events when the event occurs.

15. The control system according to claim 13,
wherein, based on the input to the execution screen, a batch request including a plurality of requests is generated, and
wherein, when the Web API receives the batch request, the processing circuitry is configured to execute a batch process including a plurality of processes corresponding to the plurality of requests, and
wherein the response generation circuitry is configured to generate a response to the batch process.

16. A control method comprising:
receiving by a Web API (Application Programming Interface) a request from a Web client which is configured to execute a Single Page Application;
executing a process with respect to a robot, the process corresponding to the request received by the Web API; and
generating a response to the request as updated data for the Single Page Application.
